(19) United States
(12) Patent Application Publication
(10) Pub. No.: US 2008/0290536 A1
(43) Pub. Date: Nov. 27, 2008

(54) TEMPERATURE CYCLING FACILITATED RELEASE OF OPHTHALMIC LENSES

(76) Inventors: Changhong Yin, St. Augustine, FL (US); Scott F. Ansell, Jacksonville, FL (US); Kent Young, Jacksonville, FL (US); Kevin P. McCabe, Augustine, FL (US); James D. Ford, Orange Park, FL (US); Azaam Alli, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/120,873

(22) Filed: May 15, 2008

Related U.S. Application Data
(60) Provisional application No. 60/940,222, filed on May 25, 2007.

(51) Int. Cl. B29D 11/00

(52) U.S. Cl. 264/2.6; 425/446

(57) ABSTRACT

This invention discloses methods and apparatus for facilitating release of an ophthalmic lens from a mold part used to form the lens. According to the present invention, the ophthalmic lens and a mold part used to form the ophthalmic lens are exposed first to an environment of reduced thermal energy and then exposed to an environment of increased thermal energy.

### RELATED PATENT APPLICATIONS

This patent application claims priority to a provisional application U.S. Ser. No. 60/940,222 which was filed on May 25, 2007 and entitled “Temperature Cycling Facilitated Release of Ophthalmic Lenses”.

### FIELD OF USE

This invention describes mold parts and ophthalmic lenses formed with the mold parts and release of the ophthalmic lenses adhered to such mold parts.

### BACKGROUND

Ophthalmic lenses are often made by cast molding, in which a monomer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. To prepare a lens using such mold parts, an uncured hydrogel lens formulation is placed between a front curve mold part and a back curve mold part. The mold parts are brought together to shape the lens formulation according to desired lens parameters. The lens formulation was subsequently cured, for example by exposure to heat and light, thereby forming a lens.

Following cure, the mold parts are separated and the lens remains adhered to one of the mold parts, it is sometimes difficult to consistently release a formed lens in a time efficient manner from a mold part to which the lens is adhered. This is contrary to the needs of a manufacturing environment wherein it is typically preferred to accomplish consistent and quick release of a formed lens from a mold.

The need for timely and consistent release of silicone hydrogel ophthalmic lenses has been addressed with the use of organic solvents. Processes have been described in which a lens is immersed in an alcohol (RCOOOR′), amide (RCONR′R″) or N-alkyl pyrrolidone for 20-40 hours and in the absence of water, or in an admixture with water as a minor component. (see e.g., U.S. Pat. No. 5,258,490). However, although some success has been realized with the known processes, the use of highly concentrated organic solutions can present safety hazards; increased risk of down time to manufacturing line; highly cost of solution; and collateral damage, due to explosion.

Alternative methods for removing a silicone hydrogel lens from a front curve (FC) mold surface during hydration involve the use of a solvent such as isopropyl alcohol (IPA). In this method 30% to 70% IPA is applied directly to the lens as it adheres to the mold surface. The solvent swells the lens and helps reduce the force holding the lens to the FC mold surface. The lens may then be removed from the mold surface. Although this method of lens release reduces the likelihood of damage to the lens, the collection and disposal of used solvent carries both an economic and environment price. For example, used IPA may be classified as hazardous waste in some states. (see e.g., U.S. Patent Application Publication No. 0186564A1).

It is desirable therefore to have additional methods and apparatus conducive to the release of silicon hydrogel ophthalmic lenses from a mold part.

### SUMMARY

Accordingly, the present invention includes processes useful in the release of an ophthalmic lens from a mold part in which the lens was formed. The lens and mold part are cycled through environments of reduced temperature and raised temperature to facilitate release of the lens from the mold part.

In some embodiments, method steps of the present invention include curing a lens siloxane forming mixture to form an ophthalmic lens in a cavity formed between a first and second mold part proximate to each other. The first and second mold parts are separated, wherein subsequent to separation, the ophthalmic lens remains adhered to a first mold part. The first mold part and lens adhered to the first mold part are exposed to an environment of reduced thermal energy and subsequently exposed to an environment of increased thermal energy, wherein the lens is released from the adhesion to the first mold part.

Embodiments can also include methods of producing an ophthalmic lens by methods described. The lens can include, for example, a silicone hydrogel formulation or a hydrogel formulation. Specific examples can include a lens formed from: acquafilcon A, balafilcon A, and lotrafilcon A, etafilcon A, genfilcon A, lenefilcon A, polymacon and galyfilcon A, narafilcon and senofilcon A.

### DESCRIPTION OF THE DRAWINGS

FIG. 1 illustrates a mold assembly according to some embodiments of the present invention.

FIG. 1A illustrates a mold part with a lens adhered thereto.

FIG. 1B illustrates a mold part and a released lens.

FIG. 2 illustrates a flow chart of exemplary steps that can be executed while implementing some embodiments of the present to release a lens from a mold part.

FIG. 3 illustrates a flow chart of exemplary steps that can be executed while implementing some embodiments of the present to release an ophthalmic lens from a mold part.

FIG. 4 illustrates apparatus for cycling a mold part through cold and hot environments.

FIG. 5 illustrates a chart with exemplary data indicating cold air treatment of mold parts and lenses.

FIG. 6 illustrates a chart with lens release time data as it relates to different mold part materials and cold water treatment.

### DETAILED DESCRIPTION OF THE INVENTION

The present invention includes molds and methods for making an ophthalmic lens. According to some embodiments of the present invention, a polymerized lens attached to one part of a multi-part mold that is used in the manufacture of an ophthalmic lens, is cycled through an environment of reduced temperature and increased temperature. Embodiments can include exposure of the lens and mold part to chilled hydration fluid followed by exposure of the lens and mold part to heated hydration fluid within specified time periods. Additional embodiments can include exposure to a chilled atmosphere followed by a heated atmosphere.

Siloxane-containing polymers generally exhibit the characteristic of being “sticky”. Ophthalmic lenses formed from siloxane monomers/polymers are largely hydrophobic and tend to regularly adhere to one or both of the front curve and back curve mold part. It is reasoned that the cause for adhesion is related to the relative surface energy of siloxane or silicone materials, which is typically less than the surface energy of mold parts in which ophthalmic lenses are formed. Release of the ophthalmic lens from the mold part requires some process to overcome this adherence.

The present invention utilizes a process of cycled cooling and then heating of the mold part and the ophthalmic lens to leverage different material properties related to such cycling and cause the silicone lens to release from a mold part to which it was adhered.

According to the present invention, the use of cycling from a cold environment followed by a hot hydration process, it becomes possible to effectively release a significant proportion of silicone hydrogel based lenses (up to 100%) from FC molds during aqueous hydration.

Contact lenses made of siloxane-containing polymers are largely hydrophobic and tend to regularly adhere to molds used to form the lens. One contributing factor for such adherence includes the surface energy of Polydimethyl siloxane (silicone) which can be about 21 mN/m (as per Adhesion and Adhesives Technology by Dr. Alphonsus Pocius, page 163, published by HANSER). This surface energy is typically lower than surface energies of commonly used mold materials. Such adherence may cause significant challenges related to the effective and consistent silicone hydrogel lens release from mold parts during aqueous hydration without the use of one or more of: isopropyl alcohol (IPA), other organic solutions or mechanical aids. The present invention teaches that such adhesion may be overcome by the specific cycling of lenses through conditions of reduced temperature first followed by hot hydration. Repeatable processes have been achieved providing excellent silicone hydrogel based lens release rates during aqueous hydration.

### Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) or an active agent is administered.

As used herein, the term “lens forming mixture” refers to a mixture of materials that can react, or be cured, to form an ophthalmic lens. Such a mixture can include polymerizable components (monomers), additives such as UV blockers and tints, photoinitiators or catalysts, and other additives one might desire in an ophthalmic lens such as a contact or intraocular lens.

In some embodiments, a preferred lens type can include a lens that is made from silicone elastomers or hydrogels, such as, for example, silicone hydrogels, fluorohydrogels, including those comprising silicone/hydrophilic macromers, silicone based monomers, initiators and additives. By way of non-limiting example, some preferred lens types can also include: narafilcon, etafilcon A, genifilcon A, lenefilcon A, polymacon, acquafilcon A, balafilcon A, lotrafilcon A, galyfilcon A, senofilcon A, silicone hydrogels.

### Molds

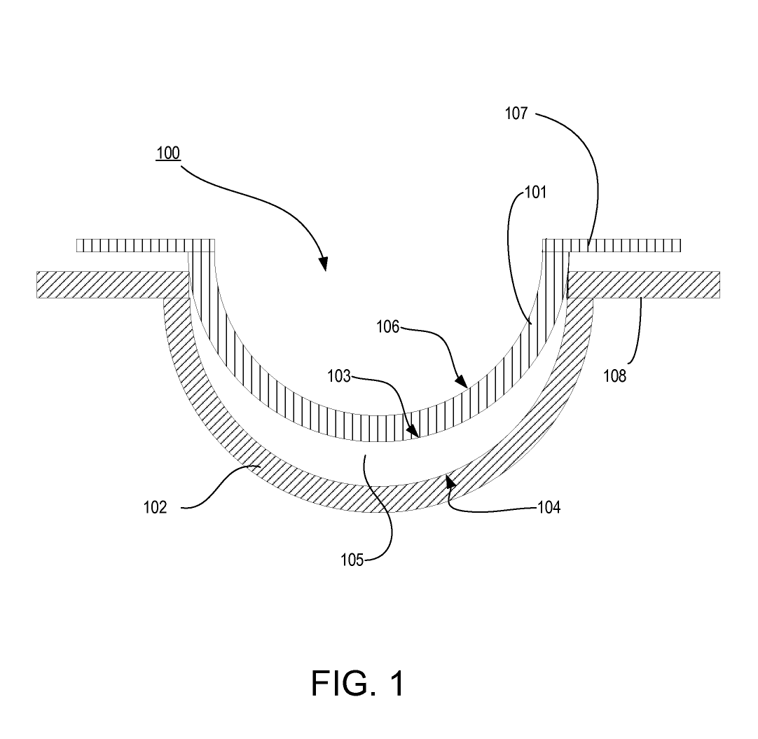

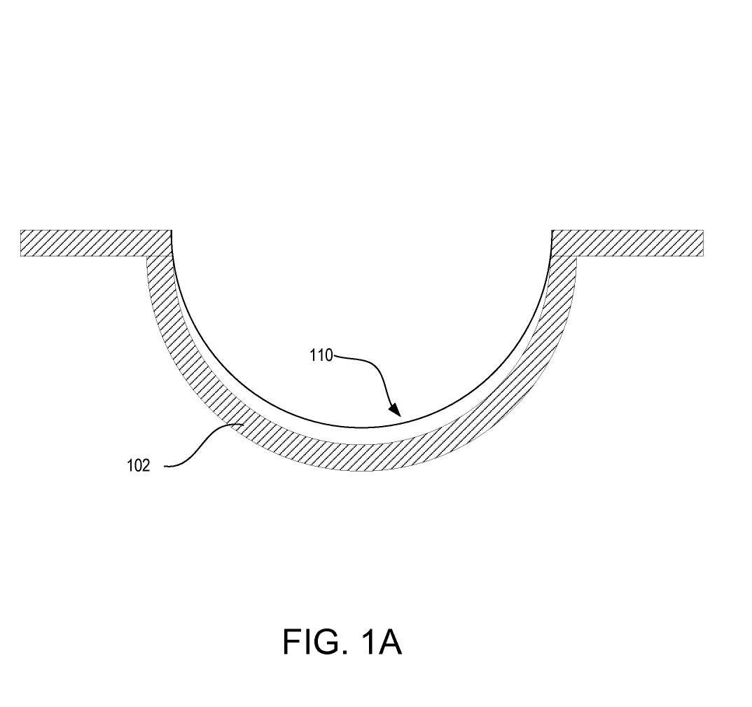

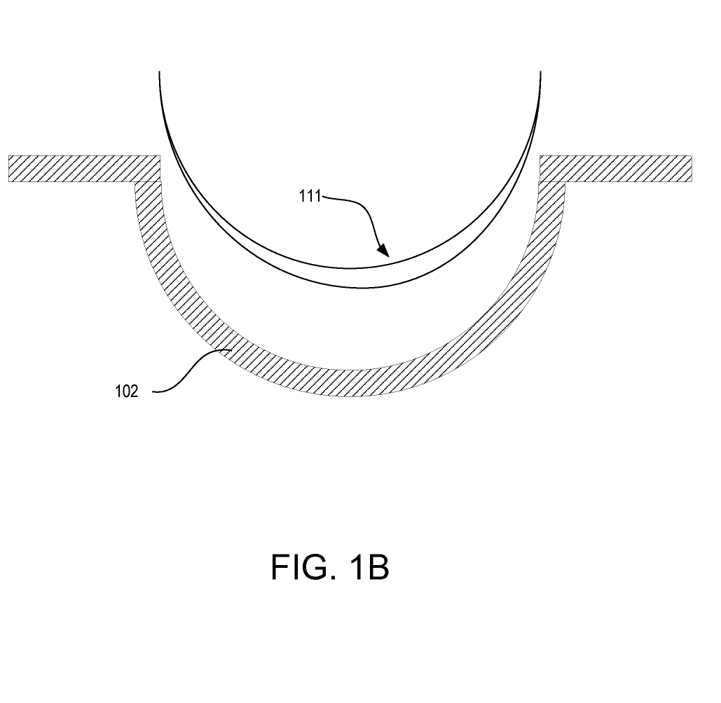

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture (not illustrated), an ophthalmic lens of a desired shape is produced. The molds and mold assemblies 100 which may be used in some preferred embodiments of this invention are made up of more than one “mold parts” or “mold pieces” 101-102. The mold parts 101-102 can be brought together such that a cavity 105 is formed there in a shape of the desired lens. This combination of mold parts 101-102 is preferably temporary. Upon formation of the lens, the mold parts 101-102 can again be separated for removal of the lens.

Thus, for example, in a preferred embodiment a mold assembly 100 is formed from two parts 101-102, a female concave piece (front piece) 102 and a male convex piece (back piece) 101 with a cavity formed between them. The portion of the concave surface 104 which makes contact with lens forming mixture has the curvature of the front curve of an ophthalmic lens to be produced in the mold assembly 100 and is sufficiently smooth and formed such that the surface of a ophthalmic lens formed by polymerization of the lens forming mixture which is in contact with the concave surface 104 is optically acceptable.

In some embodiments, the front mold piece 102 can also have an annular flange integral with, and surrounding, a circular circumferential edge 108 and extends from it in a plane normal to the axis and extending from the flange (not shown).

The back mold piece 101 has a central curved section with a concave surface 106, convex surface 103 and circular circumferential edge 107, wherein the portion of the convex surface 103 in contact with the lens forming mixture has the curvature of the back curve of a ophthalmic lens to be produced in the mold assembly 100 and is sufficiently smooth and formed such that the surface of a ophthalmic lens formed by reaction or cure of the lens forming mixture in contact with the back surface 103 is optically acceptable. Accordingly, the inner concave surface 104 of the front mold half 102 defines the outer surface of the ophthalmic lens, while the outer convex surface 103 of the base mold half 101 defines the inner surface of the ophthalmic lens.

Thermoplastics can include, for example, one or more of: polypropylene, polystyrene and alicyclic polymers and can additionally be compounded with one or more additives.

In some embodiments the thermoplastic resin can include an alicyclic polymer which refers to compounds having at least one saturated carbocyclic ring therein. The saturated carbocyclic rings may be substituted with one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents are selected from one or more members of the group consisting of halogen, hydroxyl, C₁₋₁₀alkoxycarbonyl, C₁₋₁₀alkoxy, cyano, amido, imido, and silyl. Examples of alicyclic polymers include but are not limited to polymerizable cyclobutanes, cyclopentanes, cyclohexanes, cycloheptanes, cyclooctanes, biscyclobutanes, biscyclopentanes, biscyclohexanes, biscycloheptanes, biscyclooctanes, and norbornanes. It is preferred that the at least two alicyclic polymers be polymerized by ring opening metathesis followed by hydrogenation. Since co-polymers are costly, it is preferable that the molds made from these co-polymers may be used several times to prepare lenses instead of once which is typical. For the preferred molds of the invention, they may be used more than once to produce lenses.

More particularly, examples of alicyclic polymer containing saturated carbocyclic rings include but are not limited to the following structures

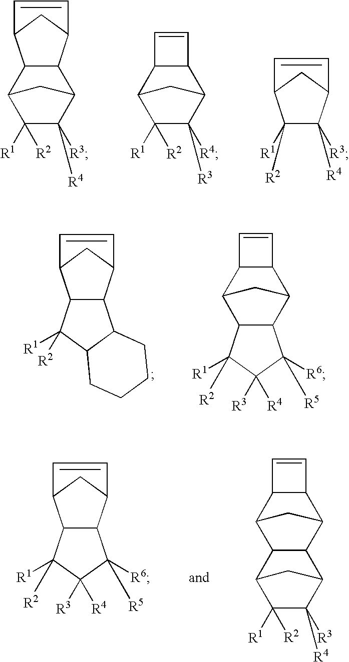

wherein R¹⁻⁶ are independently selected from one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents selected from one or more members of the group consisting of halogen, hydroxyl, C₁₋₁₀alkoxycarbonyl, C₁₋₁₀alkoxy, cyano, amido, imido and silyl. Further two or more of R¹⁻⁶ may be taken together to form an unsaturated bond, a carbocyclic ring, a carbocyclic ring containing one or more unsaturated bonds, or an aromatic ring. The preferred R¹⁻⁶ is selected from the group consisting of C₁₋₁₀alkyl and substituted C₁₋₁₀alkyl where the substituents are selected from the group consisting of halogen, hydroxyl, C₁₋₁₀alkoxycarbonyl, C₁₋₁₀alkoxy, cyano, amido, imido and silyl.

The alicyclic co-polymers consist of at least two different alicyclic polymer s. The preferred alicyclic co-polymers contain two or three different alicyclic polymer s, selected from the group consisting of

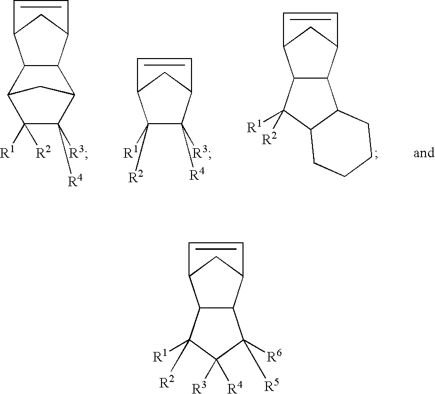

The particularly preferred alicyclic co-polymer contains two different alicyclic momoners where the generic structure of the saturated carbocyclic rings of the alicyclic polymers are of the formula

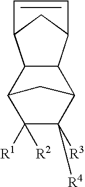

and R¹-R⁴ are C₁₋₁₀alkyl.

Typically the surface energy of the alicyclic co-polymer is between 30 and 45 dynes/cm at 25° C. A preferred alicyclic co-polymer contains two different alicyclic polymers and is sold by Zeon Chemicals L.P. under the trade name ZEONOR. Grades of ZEONOR may have glass transition temperatures ranging from 70° C. to 160° C. A specifically preferred material is ZEONOR 1060R, which according the to the manufacturer, ZEON Chemicals L.P. has an melt flow rate (“MFR”) range of 11.0 grams/10 minutes to 18.0 grams/10 minutes (as tested JISK 6719 (230° C.)), a specific gravity (H₂O=1) of 1.01 and a glass transition temperature of about 100° C.

Other mold materials that may combined with one or more additives to provide a surface energy of less then 30 mN/m and used to form an ophthalmic lens mold include, for example, Zieglar-Natta catalyst based polypropylene resins (sometimes referred to as znPP). One exemplary Zieglar-Natta catalyst based polypropylene resin is available under the name PP 9544 MED. PP 9544 MED is a clarified random copolymer for clean molding as per FDA regulation 21 CFR (c)3.2 made available by ExxonMobile Chemical Company. PP 9544 MED is a random copolymer (znPP) with ethylene group. Other exemplary Zieglar-Natta based polypropylene resins include:

Atofina Polypropylene 3761 and Atofina Polypropylene 3620WZ.

Still further, in some embodiments, the molds of the invention may contain polymers such as polypropylene, polyethylene, polystyrene, polymethyl methacrylate, modified polyolefins containing an alicyclic moiety in the main chain and cyclic polyolefins, such as, for example Zeonor and EOD 00-11 by Atofina Corporation. For example, a blend of the alicyclic co-polymers and polypropylene (metallocene catalyst process with nucleation, such as ATOFINA EOD 00-11®) may be used, where the ratio by weight percentage of alicyclic co-polymer to polypropylene ranges from about 99:1, to about 20:80 respectively. This blend can be used on either or both mold halves, where it is preferred that this blend is used on the back curve and the front curve consists of the alicyclic co-polymers.

In some preferred methods of making molds 100 according to the present invention, injection molding is utilized according to known techniques, however, embodiments can also include molds fashioned by other techniques including, for example: lathing, diamond turning, or laser cutting.

Typically, lenses are formed on at least one surface of both mold parts 101-102.

However, if need be one surface of the lenses may be formed from a mold part 101-102 and the other lens surface can be formed using a lathing method, or other methods.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

FIG. 1A illustrates a mold part 102 is illustrated with an adhered lens 110 attached thereto. FIG. 1B illustrates a lens 111 released from the mold part 102.

### Methods

The following method steps are provided as examples of processes that may be implemented according to some aspects of the present invention. It should be 30 understood that the order in which the method steps are presented are not meant to be limiting and other orders may be used to implement the invention. In addition, not all of the steps are required to implement the present invention and additional steps may be included in various embodiments of the present invention.

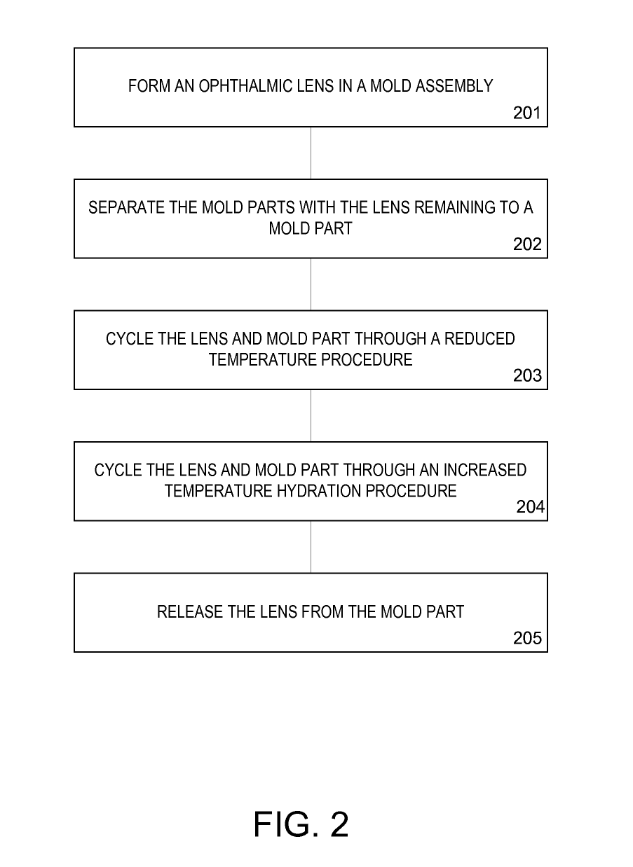

Referring now to FIG. 2, a flowchart illustrates exemplary steps that may be used to implement the present invention. At 201, an ophthalmic lens 110 is formed in a molding assembly as described above. At 202, a first ophthalmic lens mold part 101-102 is separated from a second ophthalmic lens mold part 101-102. In some preferred embodiments, the first mold part will include a FC mold part 102, although other embodiments are also within the scope of the invention. Separation may be achieved by any known process, such as, for example, mechanically prying the mold parts apart.

At 203, a first mold part 101-102 and an adhered lens 110 are cycled through exposure to a chilled environment. In some preferred embodiments, the chilled environment includes an aqueous solution cooled below ambient room temperature, and the exposure includes submersion of the first mold part 102 and the lens 110 into the chilled aqueous solution. Preferably the aqueous solution is chilled to below 10° C. and most preferably the aqueous solution is chilled to between 0° C. and 2° C. In addition, some embodiments include aqueous solution that include a surfactant or other additive that can act as an anti-freeze allowing the aqueous solution to be chilled below 0° C. Exposure to a chilled aqueous solution may be for about 30 minutes or less and preferably between 20 minutes and 30 minutes.

In other embodiments, a chilled environment can include an exposure to a chilled atmosphere instead of submersion in a liquid solution. The atmosphere can include an ambient air or a gas, such as, for example, nitrogen or CO₂. In some embodiments, a cryogenic gas can be used to lower the temperature of the mold part 102 and the lens 110. In other embodiments, a vortex chiller or other apparatus functionally capable to reduce the temperature of a gas may be used to chill the atmospheric gas to which the first lens part 102 and the lens 110 are exposed. Preferred embodiments include an atmospheric gas of below −10° C. and most preferably between −20° C. and −30° C. Exposure to a chilled air may be for about 30 minutes or less

At 204, the first mold part 102 and the lens 110 are cycled through exposed to a hydration environment with increased temperature. Preferred embodiments include exposure to an aqueous solution with a temperature of between 75° C. and 99° C. and most preferably between 90° C. and 99° C., although higher temperatures may also be used with the addition of an additive to control boiling.

Preferred methods of exposing the first mold part 102 and the lens 110 to the aqueous solution with a raised temperature include submerging the first mold part 102 and the lens 110 in the aqueous solution. Other embodiments include a tower or other apparatus providing a flow of heated solution over the first mold part 102 and the lens 110.

At 205, according to the present invention, the lens 210 is released from the first mold part 102 following the cycling through cold first, then heated environments. At 206, in some embodiments, an extraction step can be implemented to remove extraneous materials from the lens, such as, for example unreacted component. Extraction can be accomplished, for example via submersion of the released lens 111 in a moderately heated solution of approximately 40° C. to 50° C. The submersion may take place, for example for 30 minutes or less.

In preferred embodiments, cycling from a reduced temperature environment to an increased temperature environment is accomplished without artificial delay and is therefore run at the speed of a manufacturing process. As such the transfer is preferably accomplished in less than 10 minutes and more preferably in less than 2 minutes. It is also understood that embodiments can be implemented with transfer of 1 minute or less. Notwithstanding the foregoing preferred embodiments, it is within the scope of the invention to expose a mold part 102 and adhered lens 110 to a reduced thermal energy environment and then have a delay sufficient to return the lens 110 and mold part 102 to an ambient temperature and then expose the mold part 101-102 and adhered lens 110 to an environment of elevated thermal energy.

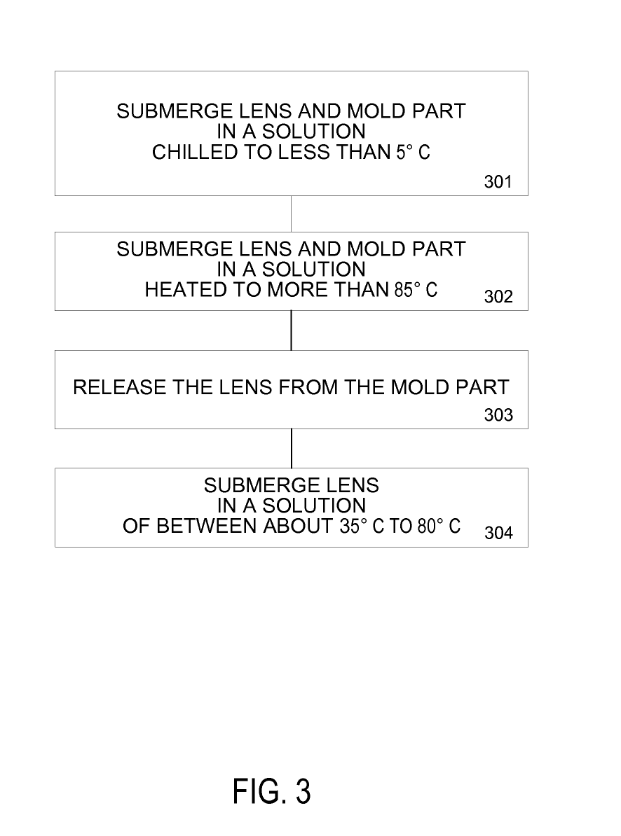

Referring now to FIG. 3, by way of non-limiting example, process steps for some embodiments are illustrated for cycling an ophthalmic lens 110 adhered to a mold part 101-102 through an environment of decreased temperature followed by an environment of increased temperature and hydration. At 301, an adhered lens 110 and mold part 101-102 can be submerged in, or otherwise expose to, an aqueous solution chilled to less than 5° C. and preferably in the 1° C. to 2° C. range. It should be noted, that although an aqueous solution is preferred, other solutions, such as for example, a surfactant solution or an organic solvent solution may also be utilized and the lens 110 and mold part 101-102 submerged therein.

As discussed above, an alternative to submersion of a mold part 101-102 and adhered lens 110 in a chilled solution is to expose the mold part 101-102 and lens to a chilled environment, such as, for example cold air chilled to between 0° C. and −25° C. Chilled air space can include for example one or more of: a refrigerated environment; a vortex cooler; and exposure to a cryogenic gas.

At 302, the lens 110 and mold part 101-102 are subsequently submerged in a solution with increased thermal energy, such as for example a solution with a temperature of 85° C. or more. As with the chilled solution, preferred embodiments include aqueous solutions, however, alternative solutions, such as a polypropylene glycol solution or an organic solvent solution are also within the scope of this invention.

At 303, the lens 110 attached to the mold part 101-102 releases and becomes a released lens 111, wherein the cycling through cold then hot environments facilitates such release.

At 304 an optional additional step can include additionally submerging the released lens 111 in an aqueous solution of moderate temperature or between about 35° C. and 80° C. Submersion in the moderate temperature solution can be useful to stabilize the lens and to extract unreacted component or other unwanted materials from the released lens 111.

### Apparatus

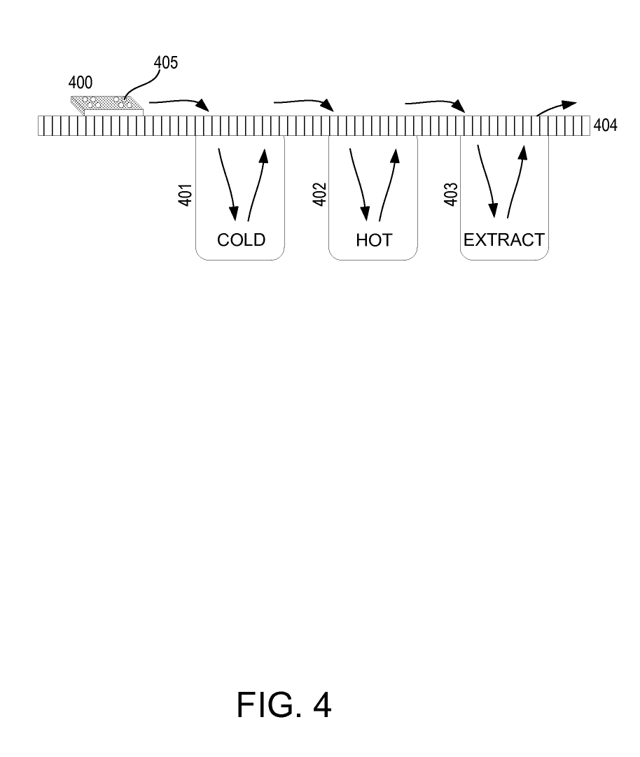

Referring now to FIG. 4, an apparatus is illustrated for implementing some embodiments of the present invention. The apparatus can include, for example, a conveyor 404, track or other locomotion apparatus to convey a carrier 400, such as a pallet, containing lenses 405. The conveyor 404 can transport the carrier 400 to the two or more hydration chambers.

A first hydration chamber 410 contains a first hydration solution which is chilled to below ambient temperature. The first hydration solution can be chilled, for example via commercial chillers to below 5° C. A second hydration chamber 402 can contain a second hydration solution heated above ambient temperature. The second hydration is preferably heated above 85° C.

In another aspect, preferred embodiments will include at least a 50° C. differential between the first hydration solution and the second hydration solution and more preferably a differential of 70° C. or more and most preferably a differential of 85° C. or more.

In some embodiments, a third hydration chamber can be included and contain a third hydration solution. Typically, the third hydration solution will be a moderate temperature, such as between 30° C. and 80° C. However in various cases a temperature range may be selected according to an amount of swelling that occurs within a particular temperature range. For example, some silicones may expand in a chilled solution and a chilled solution may therefore be advantageous, while in other embodiments, a silicone may expand in a heated solution, wherein a heated solution may be advantageous.

It should be understood, that although one chamber has been illustrated for each of various thermal energy environments, two or more chambers can be used for each thermal energy environment. Use of multiple chambers can provide advantages such as, for example, greater flexibility in hydration solution volume, as well as control of the temperature of each chamber 401-403.

### EXAMPLES

Referring now to Table 1 below, five different mold materials were used with two different monomers. In each instance in Table 1, improved release resulted from the cycling from a chilled hydration first followed by heated hydration.

Lens Release (%) during Aqueous Hydration

| | Monomer 1 | | | Monomer 2 | | |
|---|---|---|---|---|---|---|
| | | | First Cold (25 | | | First Cold (25 |
| | | | min @ 2 C.) | | | min @ 2 C.) |
| | Cold Hydration | Hot Hydration | then Hot | Cold Hydration | Hot Hydration | then Hot |
| FC Mold | Only (25 min | Only (10 min | Hydration (10 | Only (25 min | Only (10 min | Hydration (10 |
| Materials | @ 2 C.) | @ 90 C.) | min @ 90 C.) | @ 2 C.) | @ 90 C.) | min @ 90 C.) |
| Zeonor 1060 R | 0 | 21.9 | 100 | 0 | 9.4 | 96.9 |
| (control) | | | | | | |
| Zeonor 750 R | 0 | 93.8 | 100 | 0 | 0 | N/a |
| 55% Zeonor + | 0 | 25.0 | 100 | 0 | 62.5 | 100 |
| 45% PP9544 | | | | | | |
| PP9544 | 0 | 87.5 | 100 | 12.5 | 100 | 100 |
| Compounded | 0 | 0 | 100 | 12.5 | 100 | 100 |
| 50% Zeonor + | | | | | | |
| 50% S9MB | | | | | | |

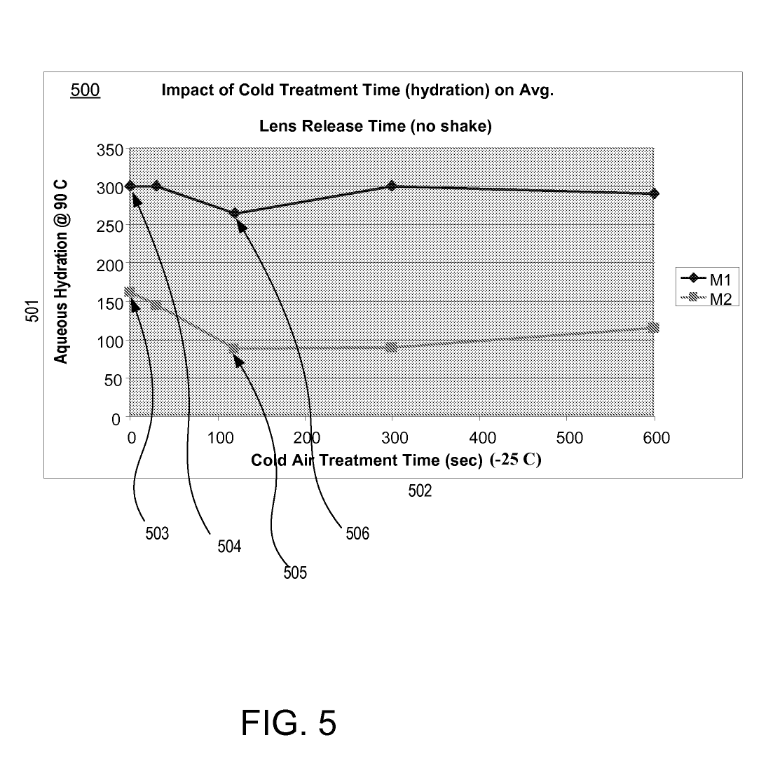

Referring now to FIG. 5, a graph 500 is provided which illustrates the time to lens release in 90° C. aqueous hydration solution following various times of exposure of a mold part 101-102 and adhered lens 110 to air chilled to −25° C. The chilled air was also effective in facilitating lens release.

As illustrated in FIG. 5, with no exposure to the chilled air, monomer 1 did not release the lens 110 from the lens mold part 101-102 and monomer 2 released on average after about 160 seconds. At 100 seconds of exposure to chilled air, both monomer one 506 and monomer two 505 exhibited a significant decrease in average time to release. Additional exposure time to chilled air did not demonstrate additional benefit in terms of average time to lens release. In addition, monomer 2 showed greater benefit to the exposure to chilled air and a more consistent benefit.

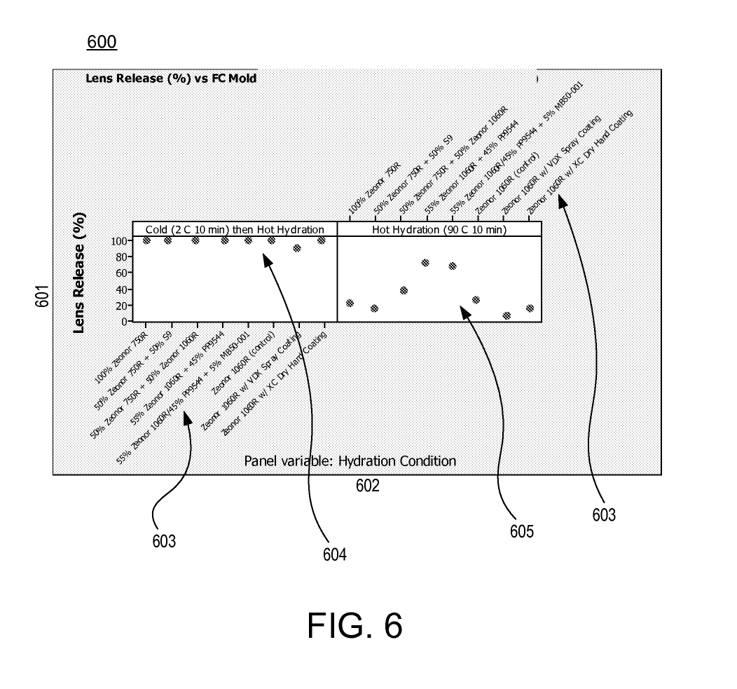

Referring now to FIG. 6, lens release time 601 is plotted in a chart 600 against hydration conditions for various mold materials 603. The hydration conditions in the first set of cases 604 included a cold cycle comprising exposure of mold parts 101-102 and an adhered lenses 110 to an aqueous hydration fluid chilled to 2° C. followed by a hot cycle with the mold part 101-102 and an adhered lenses 110 exposed to a second aqueous hydration solution heated t 90° C. Each was exposure lasted about for 10 minutes. Transfer from the cold aqueous hydration solution to the heated aqueous hydration solution was accomplished without any artificial delay, which was less than 60 seconds and in some instances less than 10 seconds. In the second set of cases 605, mold parts 101-102 and an adhered lenses 110 were exposed only to an aqueous hydration solution heated to about 90° C.

As illustrated, those lenses and mold parts exposed to a cold cycle followed by a heated cycle 604 approached 100% release irrespective of which mold material was utilized. Specific mold materials with which high rates of successful release occurred included: Zeonor 750R, Zeonor 1060R, PP9544, and the above with the additive styrene-ethylene-butadiene-styrene. Other mold variations included treatments with VDK spray coating and XC hand coating

### Conclusion

The present invention, as described above and as further defined by the claims below, provides methods of processing ophthalmic lenses and apparatus for implementing such methods, as well as ophthalmic lenses formed thereby.

What is claimed is:

1. A method of releasing an ophthalmic lens adhered to a mold part, the method comprising;
curing a lens forming mixture comprising a siloxane to form an ophthalmic lens in a cavity formed between a first and second mold part proximate to each other;
separating the first and second mold parts wherein subsequent to separation, the ophthalmic lens remains adhered to a first mold part;
exposing the first mold part and adhered lens to an environment of reduced thermal energy;
subsequent to the exposure of the first mold part and adhered lens to reduced thermal energy, exposing the first mold part and adhered lens to an environment of increased thermal energy; and
releasing the lens from the adhesion to the first mold part.

2. The method of claim 1, wherein a first mold part comprises a concave optical quality surface.

3. The method of claim 1, wherein the step of exposing the first mold part and adhered lens to an environment of reduced thermal energy comprises submerging the first mold part and adhered lens into a hydration solution with a temperature of below 5° C. for a period of 10 minutes or more.

4. The method of claim 3 wherein the first mold part and adhered lens are submerged into a hydration solution with a temperature of below 5° C. for a period of 20 minutes or more.

5. The method of claim 1, wherein the step of exposing the first mold part and adhered lens to an environment of reduced thermal energy comprises presenting a flow of a hydration solution onto the first mold part and adhered lens for a period of 10 minutes or more, wherein the hydration solution has a temperature of below 5° C.

6. The method of claim 5, wherein the first mold part and adhered lens is exposed to the flow of hydration solution onto the first mold part and adhered lens for a period of 20 minutes or more.

7. The method of claim 1 wherein the hydration solution comprises an aqueous hydration solution.

8. The method of claim 1 wherein the hydration solution comprises a non-organic solvent.

9. The method of claim 1 additionally comprising the step of:
transferring the mold part and ophthalmic lens from a first hydration tank comprising the environment of reduced thermal energy to a second hydration tank with the environment of increased thermal energy, wherein said transfer comprises a time period of 10 minutes or less.

10. The method of claim 9 wherein the time period comprises 1 minute or less.

11. The method of claim 9 wherein the mold part comprises a cyclic polyolefin.

12. The method of claim 1 wherein the environment of decreased thermal energy comprises an atmospheric gas at a temperature of about −10° C. or less.

13. The method of claim 12 additionally comprising the step of cooling the atmospheric gas via a vortex to the temperature of about −10° C. or less.

14. Apparatus for releasing an ophthalmic lens from a mold part, the apparatus comprising:
a carrier for transporting one or more ophthalmic lenses, each lens adhered to a respective mold part, wherein the carrier allows the ophthalmic lens to be exposed to hydration solution proximate to the carrier;
a first hydration chamber comprising a first hydration solution chilled below ambient temperature;
a second hydration chamber comprising a second hydration solution heated above ambient temperature;
a transport for conveying one or more ophthalmic lenses from the first hydration chamber to the second hydration chamber;

15. The apparatus of claim 14 wherein the a temperature differential between the first hydration chamber and the second hydration chamber is great enough that a majority of the one or more ophthalmic lenses release from the respective mold parts to which they were adhered subsequent to exposure of the lens and respective mold part to the first hydration solution and then the second hydration solution.

16. The apparatus of 15 wherein the exposure of the lens and respective mold part to the first hydration solution comprises a time period of about 30 minutes or less and the exposure of the lens and respective mold part to the second hydration solution comprises a time period of about 10 minutes or less.

17. The apparatus of claim 14 wherein at least one of the first hydration solution and the second hydration solution comprises an aqueous solution.

18. An ophthalmic lens produced by a method comprising the steps of:
curing a lens forming mixture comprising a siloxane to form an ophthalmic lens in a cavity formed between a first and second mold part proximate to each other;
separating the two or more mold parts wherein subsequent to separation, the ophthalmic lens remains adhered to a first mold part;
exposing the first mold part and adhered lens to an environment of reduced thermal energy;
subsequent to the exposure of the first mold part and adhered lens to reduced thermal energy, exposing the first mold part and adhered lens to an environment of increased thermal energy; and
releasing the lens from the adhesion to the first mold part.

19. The lens of claim 18 wherein the uncured lens formulation comprises narafilcon.

20. The lens of claim 11 wherein the first mold part and adhered lens are submerged into a hydration solution with a temperature of below 5° C. for a period of 20 minutes or more.
